(19) United States
(12) Patent Application Publication
(10) Pub. No.: US 2021/0303843 A1
(43) Pub. Date: Sep. 30, 2021

(54) INFORMATION PROCESSING APPARATUS

(71) Applicant: FUJIFILM Business Innovation Corp., Tokyo (JP)

(72) Inventors: Shusaku Kubo, Kanagawa (JP); Kunihiko Kobayashi, Kanagawa (JP); Shigeru Okada, Kanagawa (JP); Yusuke Suzuki, Kanagawa (JP); Shintaro Adachi, Kanagawa (JP)

(73) Assignee: FUJIFILM Business Innovation Corp., Tokyo (JP)

(21) Appl. No.: 16/931,367

(22) Filed: Jul. 16, 2020

(30) Foreign Application Priority Data
Mar. 27, 2020 (JP) 2020-058846

(51) Int. Cl. G06K 9/00; G06K 9/34

(52) U.S. Cl. CPC G06K 9/00463; G06K 2209/01; G06K 9/00469; G06K 9/344

(57) ABSTRACT

An information processing apparatus includes a processor configured to acquire an image showing a document of a closed contract, recognize characters from the acquired image, calculate positions of the recognized characters in the image, determine, based on the calculated positions, whether any other characters are present in a region anterior or posterior to a date represented by the recognized characters, and output the date as an execution date of the contract if determining that no other characters are present in the anterior region and the posterior region.

### CROSS-REFERENCE TO RELATED APPLICATIONS

This application is based on and claims priority under 35 USC 119 from Japanese Patent Application No. 2020-058846 filed Mar. 27, 2020.

### BACKGROUND

### (i) Technical Field

The present disclosure relates to an information processing apparatus.

### (ii) Related Art

Japanese Unexamined Patent Application Publication No. 2019-114193 describes a technology for identifying an issue date of a document among a plurality of dates. If a document image includes a plurality of pieces of date information, a date with time is identified as the issue date.

### SUMMARY

Aspects of non-limiting embodiments of the present disclosure relate to the following circumstances. In the technology of Japanese Unexamined Patent Application Publication No. 2019-114193, an issue date of a receipt or other documents may be identified. For example, in a case of a contract document, however, a contract execution date is not identified because time is not written around the date.

It is desirable to identify an execution date of a contract exchanged in a document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to acquire an image showing a document of a closed contract, recognize characters from the acquired image, calculate positions of the recognized characters in the image, determine, based on the calculated positions, whether any other characters are present in a region anterior or posterior to a date represented by the recognized characters, and output the date as an execution date of the contract if determining that no other characters are present in the anterior region and the posterior region.

### BRIEF DESCRIPTION OF THE DRAWINGS

An exemplary embodiment of the present disclosure will be described in detail based on the following figures, wherein:

FIG. 1 illustrates the overall configuration of a contract execution date identifying system according to an exemplary embodiment;

FIG. 2 illustrates the hardware configuration of a document processing apparatus;

FIG. 3 illustrates the hardware configuration of a reading apparatus;

FIG. 4 illustrates a functional configuration implemented by the contract execution date identifying system;

FIG. 5 illustrates an example of regions anterior and posterior to a date;

FIGS. 6A and 6B illustrate an example of erasing;

FIG. 7 illustrates an example of a displayed contract execution date;

FIG. 8 illustrates an example of an operation procedure in an identifying process;

FIG. 9 illustrates an example of a non-character region; and

FIG. 10 illustrates an example of new document images.

### DETAILED DESCRIPTION

### [1] Exemplary Embodiment

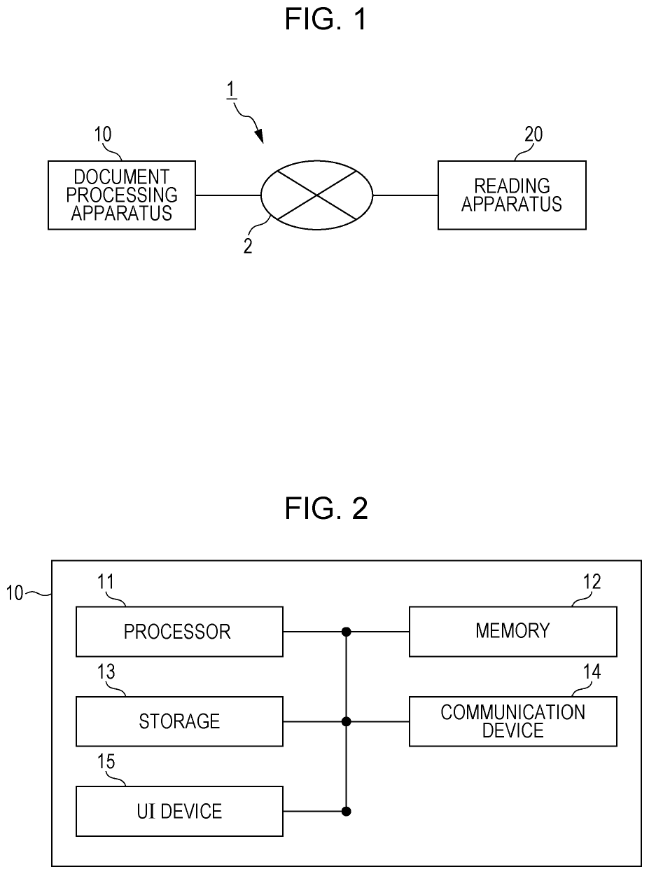

FIG. 1 illustrates the overall configuration of a contract execution date identifying system 1 according to an exemplary embodiment. The contract execution date identifying system 1 identifies a contract execution date written in a contract document. To exchange a contract, a contract document showing details of the contract is prepared.

Examples of the contract document include a sales contract, a confidentiality agreement, an outsourcing contract, a service contract, and a lease contract. Examples of the contract document also include a purchase order, an order sheet, an order acknowledgment, and an order confirmation. In companies or other organizations, closed-contract documents are stored as electronic data to organize and manage contracts. The contract execution date identifying system 1 is generally used by a person who stores contract documents (hereinafter referred to simply as “user”).

The contract execution date identifying system 1 includes a communication line 2, a document processing apparatus 10, and a reading apparatus 20. The communication line 2 is a communication system including a mobile communication network and the Internet and relays data exchange between apparatuses that access the system. The document processing apparatus 10 and the reading apparatus 20 access the communication line 2 by wire. The apparatuses may access the communication line 2 by wireless.

The reading apparatus 20 is an information processing apparatus that reads a document and generates image data showing characters or the like in the document. The reading apparatus 20 generates contract document image data by reading an original contract document. The document processing apparatus 10 is an information processing apparatus that identifies an execution date of a contract based on a contract document image. The document processing apparatus 10 identifies the execution date of the contract based on the contract document image data generated by the reading apparatus 20.

FIG. 2 illustrates the hardware configuration of the document processing apparatus 10. The document processing apparatus 10 is a computer including a processor 11, a memory 12, a storage 13, a communication device 14, and a user interface (UI) device 15. The processor 11 includes an arithmetic unit such as a central processing unit (CPU), a register, and a peripheral circuit. The memory 12 is a recording medium readable by the processor 11 and includes a random access memory (RAM) and a read only memory (ROM).

The storage 13 is a recording medium readable by the processor 11. Examples of the storage 13 include a hard disk drive and a flash memory. The processor 11 controls operations of hardware by executing programs stored in the ROM or the storage 13 with the RAM used as a working area. The communication device 14 includes an antenna and a communication circuit and is used for communications via the communication line 2.

The UI device 15 is an interface for a user of the document processing apparatus 10. For example, the UI device 15 includes a touch screen with a display and a touch panel on the surface of the display. The UI device 15 displays images and receives user's operations. The UI device 15 includes an operation device such as a keyboard in addition to the touch screen and receives operations on the operation device.

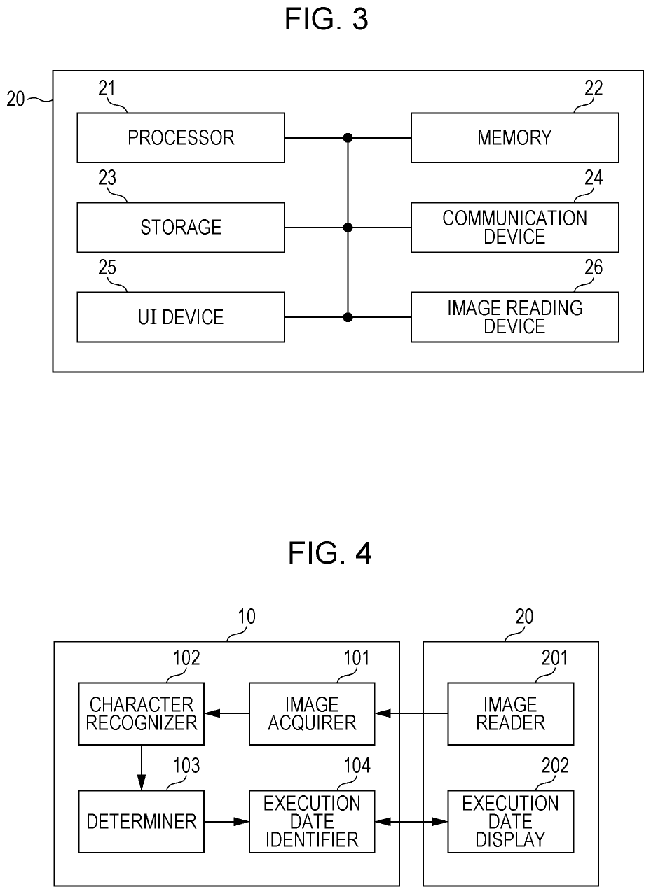

FIG. 3 illustrates the hardware configuration of the reading apparatus 20. The reading apparatus 20 is a computer including a processor 21, a memory 22, a storage 23, a communication device 24, a UI device 25, and an image reading device 26. The processor 21 to the UI device 25 are the same types of hardware as the processor 11 to the UI device 15 of FIG. 2.

The image reading device 26 reads a document and generates image data showing characters or the like (characters, symbols, pictures, or graphical objects) in the document. The image reading device 26 is a so-called scanner. The image reading device 26 has a color scan function to read colors of characters or the like in the document.

In the contract execution date identifying system 1, the processors of the apparatuses described above control the respective parts by executing the programs, thereby implementing the following functions. Operations of the functions are also described as operations to be performed by the processors of the apparatuses that implement the functions.

FIG. 4 illustrates a functional configuration implemented by the contract execution date identifying system 1. The document processing apparatus 10 includes an image acquirer 101, a character recognizer 102, a determiner 103, and an execution date identifier 104. The reading apparatus 20 includes an image reader 201 and an execution date display 202.

The image reader 201 of the reading apparatus 20 controls the image reading device 26 to read characters or the like in a document and generate an image showing the characters or the like (hereinafter referred to as “document image”). When a user sets each page of an original contract document on the image reading device 26 and starts a reading operation, the image reader 201 generates a document image in every reading operation. In this exemplary embodiment, the user causes the image reading device 26 to read the pages of the contract document one by one (not to read a two-page spread at a time).

The image reader 201 transmits image data showing the generated document image to the document processing apparatus 10. The image acquirer 101 of the document processing apparatus 10 acquires the document image in the transmitted image data as an image showing a closed-contract document. The image acquirer 101 supplies the acquired document image to the character recognizer 102. The character recognizer 102 recognizes characters from the supplied document image.

For example, the character recognizer 102 recognizes characters by using a known optical character recognition (OCR) technology. First, the character recognizer 102 analyzes the layout of the document image to identify regions including characters. For example, the character recognizer 102 identifies each line of characters. The character recognizer 102 extracts each character in a rectangular image by recognizing a blank space between the characters in each line.

The character recognizer 102 calculates the position of the extracted character (to be recognized later) in the image. For example, the character recognizer 102 calculates the character position based on coordinates in a two-dimensional coordinate system having its origin at an upper left corner of the document image. For example, the character position is the position of a central pixel in the extracted rectangular image. The character recognizer 102 recognizes the character in the extracted rectangular image by, for example, normalization, feature amount extraction, matching, and knowledge processing.

In the normalization, the size and shape of the character are converted into predetermined size and shape. In the feature amount extraction, an amount of a feature of the character is extracted. In the matching, feature amounts of standard characters are prestored and a character having a feature amount closest to the extracted feature amount is identified. In the knowledge processing, word information is prestored and a word including the recognized character is corrected into a similar prestored word if the word has no match.

The character recognizer 102 supplies the determiner 103 with character data showing the recognized characters, the calculated positions of the characters, and a direction of the characters (e.g., a lateral direction if the characters are arranged in a row). Based on the calculated character positions, the determiner 103 determines whether any other characters are present in a region anterior or posterior to a date represented by the read characters (hereinafter referred to as “anterior or posterior region”). The terms “anterior” and “posterior” herein refer to anterior and posterior positions in the direction of the characters.

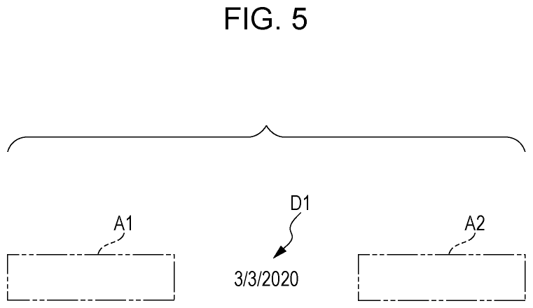

FIG. 5 illustrates an example of the regions anterior and posterior to the date. FIG. 5 illustrates an anterior region A1 and a posterior region A2 relative to a date image D1 showing “Mar. 3, 2020”. The anterior region A1 is a rectangular region on the left of “3” and extends to the left end of the document image. The posterior region A2 is a rectangular region on the right of “2020” and extends to the right end of the document image.

For example, the determiner 103 identifies, as the date image, a character string including a numeral indicating “Month”, a slash mark, a numeral indicating “Day”, a slash mark, and a numeral indicating “Year” in this order. If an inappropriate numeral is included (e.g., “13” as the numeral indicating “Month”), the determiner 103 may exclude the character string from the date image.

The determiner 103 makes the determination described above after a portion that satisfies a predetermined condition (hereinafter referred to as “erasing condition”) is erased from the document image acquired by the image acquirer 101. The portion that satisfies the erasing condition is unnecessary for determination of a contract execution date and is hereinafter referred to also as “unnecessary portion”. In this exemplary embodiment, the determiner 103 erases a portion having a specific color from the document image as the unnecessary portion. Examples of the specific color include red of a seal and navy blue of a signature.

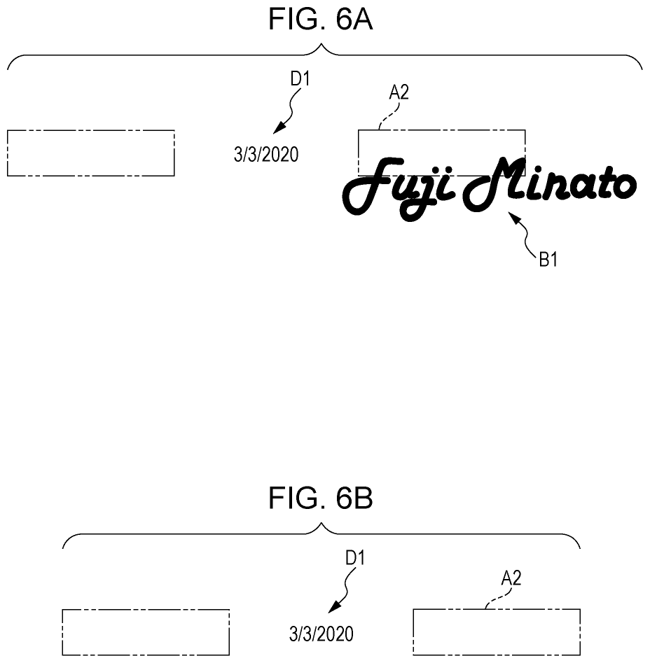

FIGS. 6A and 6B illustrate an example of the erasing. In FIG. 6A, a signature Bi that reads “Fuji Minato” is in the posterior region A2 relative to the date image D1 of FIG. 5. The signature B1 is navy blue. The determiner 103 erases the navy blue portion from the document image to erase the signature B1 as illustrated in FIG. 6B. The determiner 103 determines whether any other characters are present in the anterior or posterior region in the document image where the signature B1 is erased. In the example of FIGS. 6A and 6B, the determiner 103 determines that no other characters are present in the anterior and posterior regions.

The determiner 103 supplies the determination result to the execution date identifier 104. If the determiner 103 determines that no other characters are present in the anterior and posterior regions, the execution date identifier 104 identifies the date as the contract execution date. In the example of FIGS. 6A and 6B, the execution date identifier 104 identifies the date “Mar. 3, 2020” in the date image D1 as the contract execution date because no other characters are present in the regions anterior and posterior to the date image D1.

The execution date identifier 104 outputs the identified contract execution date, that is, the date identified through the determination that no other characters are present in the anterior and posterior regions. In this exemplary embodiment, the execution date identifier 104 transmits execution date data showing the identified contract execution date to the reading apparatus 20 that has transmitted the document image data. The execution date display 202 of the reading apparatus 20 displays the output contract execution date.

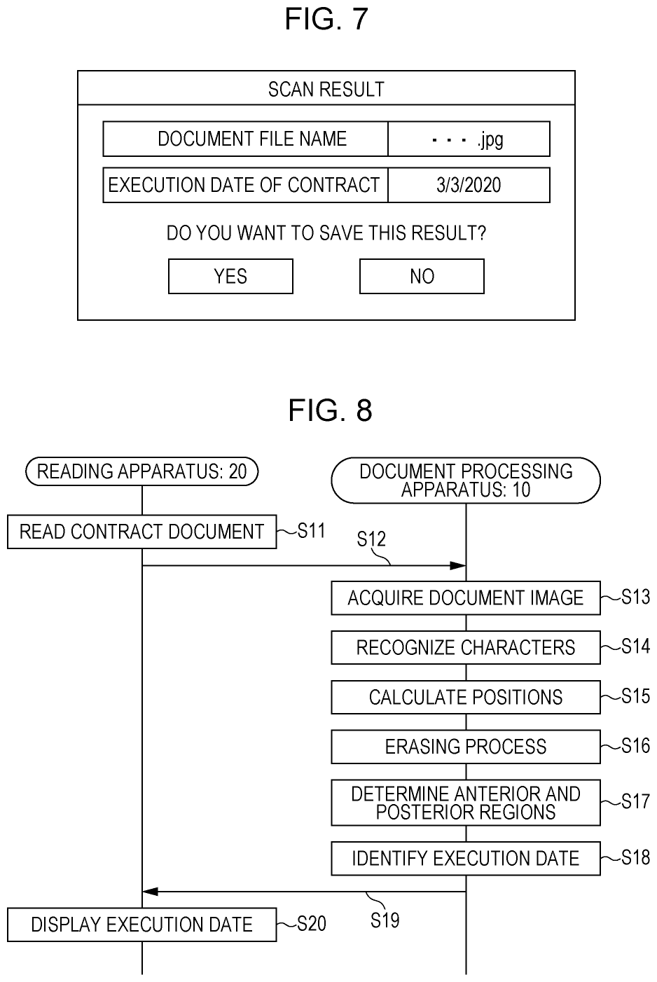

FIG. 7 illustrates an example of the displayed contract execution date. In the example of FIG. 7, the execution date display 202 displays items “Document file name” and “Execution date of contract”, a confirmation message “Do you want to save this result?”, a “Yes” button, and a “No” button. The document file name is the name of a file of the document image data.

In response to the user pressing the “Yes” button, for example, the execution date display 202 notifies the document processing apparatus 10 that the “Yes” button is pressed and the execution date identifier 104 stores the image data and the contract execution date in association with each other. The image data and the contract execution date may be stored in the reading apparatus 20 or an external apparatus (e.g., a contract document database apparatus) (not illustrated) instead of the document processing apparatus 10.

With the configurations described above, the apparatuses in the contract execution date identifying system 1 perform an identifying process for identifying the contract execution date.

FIG. 8 illustrates an example of an operation procedure in the identifying process. First, the reading apparatus 20 (image reader 201) reads characters or the like in a set contract document and generates a document image (Step S11). Next, the reading apparatus 20 (image reader 201) transmits image data showing the generated document image to the document processing apparatus 10 (Step S12).

The document processing apparatus 10 (image acquirer 101) acquires the document image in the transmitted image data as an image showing a closed-contract document (Step S13). Next, the document processing apparatus 10 (character recognizer 102) recognizes characters from the acquired document image (Step S14). Next, the document processing apparatus 10 (character recognizer 102) calculates the positions of the recognized characters in the image (Step S15). Steps S14 and S15 may be performed in reverse or simultaneously.

Next, the document processing apparatus 10 (determiner 103) erases an unnecessary portion (portion that satisfies the erasing condition) from the document image (Step S16). Step S16 may be performed prior to or simultaneously with Steps S14 and S15. Next, the document processing apparatus 10 (determiner 103) determines, based on the calculated character positions, whether any other characters are present in a region anterior or posterior to a date represented by the read characters (Step S17).

If determination is made in Step S16 that no other characters are present in the anterior and posterior regions, the document processing apparatus 10 (execution date identifier 104) identifies the date as a contract execution date (Step S18) and outputs the identified contract execution date to the reading apparatus 20 (Step S19). The reading apparatus 20, (execution date display 202) displays the output contract execution date (Step S20).

The contract execution date in the contract document is generally written alone in a line instead of being written in a sentence. If no other characters are present in the anterior and posterior regions, there is a strong possibility that the date is the contract execution date.

However, a signature may be present in the anterior or posterior region as illustrated in FIG. 6A. In this case, the contract execution date is not identified because determination is made that any characters are present in the anterior or posterior region. In this exemplary embodiment, such an unnecessary portion is erased.

### [2] Modified Examples

### [2-1] Document Image

In the exemplary embodiment, the image acquirer 101 acquires a document image generated by reading an original contract document but may acquire, for example, a document image shown in contract document data electronically created by an electronic contract exchange system.

### [2-2] Output Destination

The execution date identifier 104 outputs an identified contract execution date to the reading apparatus 20 that has transmitted a document image. For example, the execution date identifier 104 may output the contract execution date to an external apparatus that stores electronic data of contract documents. The execution date identifier 104 may display the contract execution date on a display of the document processing apparatus 10 or cause an external printer to print the contract execution date.

### [2-3] Erasing of Unnecessary Portion

The determiner 103 erases a portion having a specific color in a document image as an unnecessary portion but the unnecessary portion is not limited to that portion. In this modified example, the determiner 103 erases, from the acquired document image, a portion other than a region including recognized characters as the unnecessary portion (portion that satisfies the erasing condition).

For example, the determiner 103 identifies a smallest quadrangle enclosing the recognized characters as the character region. The determiner 103 erases a portion other than the identified character region as the unnecessary portion. After the unnecessary portion is erased, the execution date identifier 104 identifies a contract execution date similarly to the exemplary embodiment.

The document image obtained by reading the contract document may include a shaded region due to a fold line or a binding tape between pages. If the shaded region is read and erroneously recognized as characters, the contract execution date is not identified. In this modified example, the erasing process described above is performed as a countermeasure.

### [2-3] Conversion of Unnecessary Portion

The determiner 103 erases an unnecessary portion in a document image but may convert the document image into an image with no unnecessary portion. As a result, the unnecessary portion is erased. To convert the image, for example, machine learning called generative adversarial networks (GAN) may be used.

The GAN is an architecture in which two networks (generator and discriminator) learn competitively. The GAN is often used as an image generating method. The generator generates a false image from a random noise image. The discriminator determines whether the generated image is a “true” image included in teaching data. For example, the determiner 103 generates a contract document image with no signature by the GAN and the execution date identifier 104 identifies a contract execution date based on the generated image similarly to the exemplary embodiment.

Thus, the execution date identifier 104 of this modified example identifies the execution date based on the image obtained by converting the acquired document image.

### [2-4] Reading Method

In the exemplary embodiment, the image reader 201 generates a document image by reading each page of a contract document but may generate a document image by reading a two-page spread at a time. In this case, document images for front and back covers are generated in a size corresponding to one page of the contract document and document images for the other pages are generated in a size corresponding to a two-page spread of the contract document.

### [2-5] Split of Document Image

If a document image (image showing a document of a contract) acquired by the image acquirer 101 has a size corresponding to two pages of the document, the determiner 103 makes the determination after the document image is split into halves. The split of the two-page size document image into halves means that two document images each corresponding to one page are generated.

The document image is generally rectangular. For example, the determiner 103 detects a region without recognized characters and with a maximum width (hereinafter referred to as “non-character region”) in a rectangular region without the corners of the acquired document image between two sides facing each other. If the width is equal to or larger than a threshold, the determiner 103 determines that the document image has a size corresponding to two pages of the contract document. The term “width” herein refers to a dimension in a direction orthogonal to a direction from one side to the other.

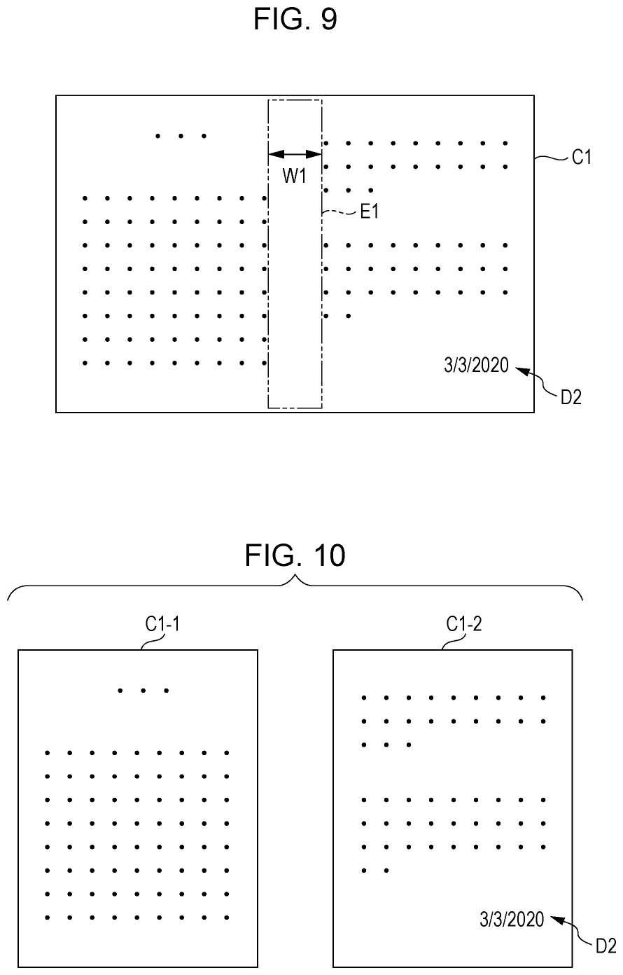

FIG. 9 illustrates an example of the non-character region. FIG. 9 illustrates a non-character region E1 in a document image C1 having a size corresponding to two pages. The non-character region E1 is present between right and left pages. The determiner 103 determines that upper and lower margins of each page are not non-character regions because the margins have corners of the document image C1. The document image C1 includes a date image D2. If a width W1 of the non-character region E1 is equal to or larger than the threshold, the determiner 103 determines that the document image C1 has a size corresponding to two pages of a contract document.

When the determination is made as described above, for example, the determiner 103 generates new document images by splitting the document image C1 along a line passing through the center of the non-character region E1 in the width direction.

FIG. 10 illustrates an example of the new document images. In FIG. 10, the determiner 103 generates a document image C1-1 on the left page of the document image C1, and a document image C1-2 on the right page of the document image C1. The document image C1-2 includes the date image D2.

The determiner 103 makes determination about anterior and posterior regions in each of the document images C1-1 and C1-2 and determines that no other characters are present in regions anterior and posterior to the date image D2. As a result, the date image D2 is identified as a contract execution date. In the document image C1, determination is made that other characters are present in the region anterior or posterior to the date image D2 because characters on the left page are present in the region anterior to the date image D2.

For example, in electronic data of a contract document, four-up, eight-up, or other page layouts may be selected and three or more pages may be included in one image. If the document image (image showing the contract document) acquired by the image acquirer 101 has a size corresponding to three or more pages of the document, the determiner 103 makes the determination after the document image is split into as many images as the pages.

For example, if the document image has two or more non-character regions each having a width equal to or larger than the threshold, the determiner 103 determines that the number of regions demarcated by the non-character regions is the number of pages in one image. After the determination, for example, the determiner 103 generates new document images by splitting the document image along lines passing through the centers of the non-character regions in the width direction.

### [2-6] Combination of Plurality of Contract Documents

Depending on contents of contracts, one contract document may include a plurality of contracts. In this case, two or more contract execution dates are written in one contract document because the respective contracts have their contract execution dates. If one contract document has two or more dates with no other characters in regions anterior and posterior to the dates, the execution date identifier 104 first extracts character strings that represent titles of the contracts.

The title of a contract is generally represented by characters in a font size larger than that of characters used in the body of the contract. For example, the execution date identifier 104 compares the sizes of characters in a plurality of document images, detects a character string including characters in a font size larger than that of general characters, and extracts the character string as the title of the contract in the document images. If the acquired document images show one contract document including two contracts, two titles are extracted.

The execution date identifier 104 splits the contract document based on the positions of the extracted character strings that represent the titles, and outputs contract execution dates in new contract documents obtained by the splitting. The title of a contract generally appears in the top page of a contract document. Therefore, the execution date identifier 104 splits the contract document at a point between a page including the latter title and a page preceding the page including the title.

### [2-7] Simple Determination

Some contract documents may have one date alone. In this case, there is a strong probability that the date is a contract execution date. If a contract document has one date represented by recognized characters, the execution date identifier 104 may identify and output the date as a contract execution date.

### [2-8] Narrowing of Determination Range

In many contract documents, contract execution dates are written at similar positions. For example, each execution date is written after the body of the contract is written. The execution date may be written at the beginning of the contract document. In this modified example, the determiner 103 first determines whether any other characters are present in a region anterior or posterior to a date in a specific region in a document image.

Examples of the specific region include a page with a predetermined page number at the beginning of a contract document and a page with a predetermined page number at the end of a contract document. If determination is made that no other characters are present in the regions anterior or posterior to the date in the specific region, the execution date identifier 104 confirms the determination result. In this case, the execution date identifier 104 identifies and outputs the date as a contract execution date.

If determination is made that any other characters are present in a region anterior or posterior to the date in the specific region, the determiner 103 determines whether any other characters are present in a region anterior or posterior to a date in a region other than the specific region.

### [2-9] Functional Configuration

In the contract execution date identifying system 1, the method for implementing the functions illustrated in FIG. 4 is not limited to the method described in the exemplary embodiment. For example, the document processing apparatus 10 may have all the elements in one housing or may have the elements distributed in two or more housings like computer resources provided in a cloud service.

At least one of the image acquirer 101, the character recognizer 102, the determiner 103, or the execution date identifier 104 may be implemented by the reading apparatus 20. At least one of the image reader 201 or the execution date display 202 may be implemented by the document processing apparatus 10.

In the exemplary embodiment, the determiner 103 performs both the process of erasing an unnecessary portion and the process of making determination about anterior and posterior regions. Those processes may be performed by different functions. Further, the operations of the determiner 103 and the execution date identifier 104 may be performed by one function. In short, the configurations of the apparatuses that implement the functions and the operation ranges of the functions may freely be determined as long as the functions illustrated in FIG. 4 are implemented in the contract execution date identifying system as a whole.

### [2-10] Processor

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

### [2-11] Category

The exemplary embodiment of the present disclosure may be regarded not only as information processing apparatuses such as the document processing apparatus 10 and the reading apparatus 20 but also as an information processing system including the information processing apparatuses (e.g., contract execution date identifying system 1). The exemplary embodiment of the present disclosure may also be regarded as an information processing method for implementing processes to be performed by the information processing apparatuses, or as programs causing computers of the information processing apparatuses to implement functions. The programs may be provided by being stored in recording media such as optical discs, or may be installed in the computers by being downloaded via communication lines such as the Internet.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
acquire an image showing a document of a closed contract,
recognize characters from the acquired image,
calculate positions of the recognized characters in the image,
determine, based on the calculated positions, whether any other characters are present in a region anterior or posterior to a date represented by the recognized characters, and
output the date as an execution date of the contract if determining that no other characters are present in the anterior region and the posterior region.

2. The information processing apparatus according to claim 1, wherein the processor makes the determination after a portion that satisfies a predetermined condition is erased from the acquired image.

3. The information processing apparatus according to claim 2, wherein the portion that satisfies the condition is a portion having a specific color.

4. The information processing apparatus according to claim 2, wherein the portion that satisfies the condition is a portion other than a region including the recognized characters.

5. The information processing apparatus according to claim 1, wherein the processor makes the determination based on an image obtained by converting the acquired image.

6. The information processing apparatus according to claim 1, wherein, if the acquired image has a size corresponding to two pages of the document, the processor makes the determination after the image is split into halves.

7. The information processing apparatus according to claim 2, wherein, if the acquired image has a size corresponding to two pages of the document, the processor makes the determination after the image is split into halves.

8. The information processing apparatus according to claim 3, wherein, if the acquired image has a size corresponding to two pages of the document, the processor makes the determination after the image is split into halves.

9. The information processing apparatus according to claim 4, wherein, if the acquired image has a size corresponding to two pages of the document, the processor makes the determination after the image is split into halves.

10. The information processing apparatus according to claim 5, wherein, if the acquired image has a size corresponding to two pages of the document, the processor makes the determination after the image is split into halves.

11. The information processing apparatus according to claim 6,
wherein the image is rectangular, and
wherein the processor is configured to
detect a region without the recognized characters and with a maximum width in a rectangular region without corners of the image between two sides facing each other, and
determine that the image has the size corresponding to two pages of the document if the width is equal to or larger than a threshold.

12. The information processing apparatus according to claim 7,
wherein the image is rectangular, and
wherein the processor is configured to
detect a region without the recognized characters and with a maximum width in a rectangular region without corners of the image between two sides facing each other, and
determine that the image has the size corresponding to two pages of the document if the width is equal to or larger than a threshold.

13. The information processing apparatus according to claim 8,
wherein the image is rectangular, and
wherein the processor is configured to
detect a region without the recognized characters and with a maximum width in a rectangular region without corners of the image between two sides facing each other, and
determine that the image has the size corresponding to two pages of the document if the width is equal to or larger than a threshold.

14. The information processing apparatus according to claim 9,
wherein the image is rectangular, and
wherein the processor is configured to
detect a region without the recognized characters and with a maximum width in a rectangular region without corners of the image between two sides facing each other, and
determine that the image has the size corresponding to two pages of the document if the width is equal to or larger than a threshold.

15. The information processing apparatus according to claim 10,
wherein the image is rectangular, and
wherein the processor is configured to
detect a region without the recognized characters and with a maximum width in a rectangular region without corners of the image between two sides facing each other, and
determine that the image has the size corresponding to two pages of the document if the width is equal to or larger than a threshold.

16. The information processing apparatus according to claim 1, wherein, if the acquired image has a size corresponding to three or more pages of the document, the processor makes the determination after the image is split into as many images as the pages.

17. The information processing apparatus according to claim 1, wherein the processor is configured to, if the document has two or more dates with no other characters in regions anterior and posterior to the dates,
extract character strings that represent titles of contracts,
split the document based on positions of the extracted character strings, and
output execution dates of the contracts in documents obtained by splitting the document.

18. The information processing apparatus according to claim 1, wherein, if the document has one date represented by the recognized characters, the processor outputs the date as the execution date of the contract.

19. The information processing apparatus according to claim 1, wherein the processor is configured to
determine whether any other characters are present in a region anterior or posterior to a date in a specific region in the image, and
if any other characters are present in the region anterior or posterior to the date in the specific region, determine whether any other characters are present in a region anterior or posterior to a date in a region other than the specific region.

20. The information processing apparatus according to claim 19, wherein the specific region is a page with a predetermined page number at a beginning of the document or a page with a predetermined page number at an end of the document.
